(19) United States
(12) Patent Application Publication
(10) Pub. No.: US 2026/0142084 A1
(43) Pub. Date: May 21, 2026

(54) MULTILAYER CERAMIC CAPACITOR

(71) Applicant: SAMSUNG ELECTRO-MECHANICS CO., LTD., Suwon-si (KR)

(72) Inventors: Moonchul Lee, Suwon-si (KR); Seung-Hun Han, Suwon-si (KR); Taejoon Park, Suwon-si (KR); Sung-Min Cho, Suwon-si (KR); Hongseok Kim, Suwon-si (KR); Sangwook Lee, Suwon-si (KR); Jungmin Kim, Suwon-si (KR); Hyejin Park, Suwon-si (KR); Byungwoo Kang, Suwon-si (KR)

(73) Assignee: SAMSUNG ELECTRO-MECHANICS CO., LTD., Suwon-si (KR)

(21) Appl. No.: 19/097,500

(22) Filed: Apr. 1, 2025

(30) Foreign Application Priority Data
Nov. 20, 2024 (KR) 10-2024-0166047

(51) Int. Cl. H01G 4/232; H01G 4/30

(52) U.S. Cl. CPC H01G 4/2325; H01G 4/30

(57) ABSTRACT

A multilayer ceramic capacitor including: a body including a plurality of internal electrodes stacked in a first direction with a dielectric layer interposed therebetween, and having a first surface and a second surface disposed opposite each other in the first direction; and an external electrode disposed outside the body. The external electrode includes a connection portion connected to the plurality of internal electrodes, a first band portion connected to the connection portion and covering a portion of the first surface, a second band portion connected to the connection portion and covering a portion of the second surface, a first conductive resin layer covering the first band portion and exposing the connection portion, and a second conductive resin layer covering the second band portion and exposing the connection portion. A thickness of the second conductive resin layer is greater than a thickness of the first conductive resin layer.

### CROSS-REFERENCE TO RELATED APPLICATION

This application claims priority to and the benefit of Korean Patent Application No. 10-2024-0166047 filed in the Korean Intellectual Property Office on Nov. 20, 2024, the entire contents of which are incorporated herein by reference.

### BACKGROUND

### 1. Technical Field

The present disclosure relates to a multilayer ceramic capacitor.

### 2. Description of the Related Art

Electronic components using a ceramic material may include a capacitor, an inductor, a piezoelectric element, a varistor, a thermistor, and the like. Among these ceramic electronic components, multilayer ceramic capacitors (MLCCs) may be used in a variety of electronic devices due to their advantages such as a small size, a high capacity, and ease of mounting.

For example, the multilayer ceramic capacitors may be used in chip-type condensers that are mounted on substrates of various electronic products such as imaging devices such as liquid crystal displays (LCDs), plasma display panels (PDPs), and organic light-emitting diodes (OLEDs), computers, personal portable devices, and smartphones and that serve to charge or discharge electricity.

The multilayer ceramic capacitor may include an internal electrode disposed inside a body and an external electrode disposed outside the body and connected to the internal electrode. In some cases, the external electrode may include an electrode layer and a conductive resin layer covering the electrode layer, which requires a structure for the external electrode that can reduce equivalent series resistance (ESR) while increasing the bending strength.

### SUMMARY

The present disclosure attempts to provide a multilayer ceramic capacitor capable of reducing equivalent series resistance while increasing the bending strength.

However, problems to be solved by embodiments of the present disclosure are not limited to the above-mentioned problems and may be variously expanded within a range of the spirit of the present disclosure included in the embodiments.

According to an embodiment, provided is a multilayer ceramic capacitor (MLCC) including: a body comprising a plurality of internal electrodes stacked in a first direction with a dielectric layer interposed therebetween, the body including a first surface and a second surface disposed opposite each other in the first direction; and an external electrode disposed outside the body, and connected to the plurality of internal electrodes, wherein the external electrode includes a connection portion connected to the plurality of internal electrodes in a second direction intersecting the first direction, a first band portion connected to the connection portion and covering a portion of the first surface, a second band portion connected to the connection portion and covering a portion of the second surface, a first conductive resin layer covering the first band portion and exposing the connection portion, and a second conductive resin layer covering the second band portion and exposing the connection portion, and wherein a thickness of the second conductive resin layer is greater than a thickness of the first conductive resin layer.

An average thickness of the second conductive resin layer may be at least twice an average thickness of the first conductive resin layer.

The first conductive resin layer may cover a portion of the first band portion, and the second conductive resin layer may cover a portion of the second band portion.

The first conductive resin layer may cover a portion of the first surface, and the second conductive resin layer may cover a portion of the second surface.

In a region where the first conductive resin layer covers the first surface, a length of a portion where the first conductive resin layer and the first surface are in contact with each other may be greater than the thickness of the first conductive resin layer.

In a region where the second conductive resin layer covers the second surface, a length of a portion where the second conductive resin layer and the second surface are in contact with each other may be greater than the thickness of the second conductive resin layer.

An outer surface of the first conductive resin layer may include a curved surface, and an outer surface of the second conductive resin layer may include a curved surface.

A length of the first conductive resin layer may be greater than a length of the first band portion, and a length of the second conductive resin layer may be greater than a length of the second band portion.

A length of the first conductive resin layer may be greater than a thickness thereof, and a length of the second conductive resin layer may be greater than a thickness thereof.

Lc/500≤t1<t2≤Lc/50 where a length of the body is Lc, the thickness of the first conductive resin layer is t1, and the thickness of the second conductive resin layer is t2.

LC/250≤Tz≤Lc/25 where a length of the body is Lc, and a thickness of the connection portion is Tz.

The body may further include a third surface and a fourth surface disposed opposite each other in a third direction simultaneously intersecting the first direction and the second direction, the external electrode may further include a third band portion connected to the connection portion and covering a portion of the third surface, a fourth band portion connected to the connection portion and covering a portion of the fourth surface, a third conductive resin layer covering the third band portion, and a fourth conductive resin layer covering the fourth band portion, and wherein the first conductive resin layer, the third conductive resin layer, and the fourth conductive resin layer may have the same average thickness.

The first conductive resin layer, the third conductive resin layer, and the fourth conductive resin layer may have the same average thickness that is smaller than an average thickness of the second conductive resin layer.

The body may further include a third surface and a fourth surface disposed opposite each other in a third direction simultaneously intersecting the first direction and the second direction, the external electrode may further include a third band portion connected to the connection portion and covering a portion of the third surface, a fourth band portion connected to the connection portion and covering a portion of the fourth surface, a third conductive resin layer covering the third band portion, and a fourth conductive resin layer covering the fourth band portion, and wherein each of an average thickness of the first conductive resin layer, an average thickness of the third conductive resin layer, and an average thickness of the fourth conductive resin layer may be smaller than an average thickness of the second conductive resin layer.

The body may further include a third surface and a fourth surface disposed opposite each other in a third direction simultaneously intersecting the first direction and the second direction, the external electrode may further include a third band portion connected to the connection portion and covering a portion of the third surface, a fourth band portion connected to the connection portion and covering a portion of the fourth surface, a third conductive resin layer covering the third band portion, and a fourth conductive resin layer covering the fourth band portion, and wherein the first conductive resin layer and the fourth conductive resin layer may have the same average thickness that is smaller than each of an average thickness of the second conductive resin layer and an average thickness of the third conductive resin layer.

The average thickness of the third conductive resin layer may be smaller than the average thickness of the second conductive resin layer.

The body may further include a third surface and a fourth surface disposed opposite each other in a third direction simultaneously intersecting the first direction and the second direction, the external electrode may further include a third band portion connected to the connection portion and covering a portion of the third surface, a fourth band portion connected to the connection portion and covering a portion of the fourth surface, a third conductive resin layer covering the third band portion, and a fourth conductive resin layer covering the fourth band portion, and wherein the first conductive resin layer and the third conductive resin layer may have the same average thickness that is smaller than each of an average thickness of the second conductive resin layer and an average thickness of the fourth conductive resin layer.

The average thickness of the fourth conductive resin layer may be smaller than the average thickness of the second conductive resin layer.

The first conductive resin layer and the second conductive resin layer may each include a metal and a resin.

The MLCC may further include a plating layer covering the external electrode.

The multilayer ceramic capacitor according to the embodiment may increase the bending strength and reduce the equivalent series resistance by increasing the thickness of the conductive resin layer disposed on the mounting surface of the board.

### BRIEF DESCRIPTION OF THE DRAWINGS

FIG. 1 is a perspective view schematically showing a multilayer ceramic capacitor according to an embodiment.

FIG. 2 is an exploded perspective view schematically showing a stacking structure of internal electrodes in the multilayer ceramic capacitor in FIG. 1.

FIG. 3 is a plan view schematically showing a first internal electrode of the multilayer ceramic capacitor in FIG. 1.

FIG. 4 is a plan view schematically showing a second internal electrode of the multilayer ceramic capacitor in FIG. 1.

FIG. 5 is a cross-sectional view taken along line I-I′ in FIG. 1.

FIG. 6 is a cross-sectional view taken along line II-II′ in FIG. 1.

FIG. 7 is a cross-sectional view taken along line III-III′ in FIG. 1.

FIG. 8 is a partial cross-sectional view schematically showing region A in FIG. 5.

FIG. 9 is a partial cross-sectional view schematically showing region B in FIG. 5.

FIG. 10 is a graph showing a result of a relative comparison of stress changes as the thickness of a conductive resin layer increases.

FIG. 11 is a cross-sectional view schematically showing the multilayer ceramic capacitor shown in FIG. 1 as mounted on a circuit board.

### DETAILED DESCRIPTION

Hereinafter, embodiments of the present disclosure are described in detail with reference to the accompanying drawings so that those skilled in the art to which the present disclosure pertains may easily practice the present disclosure. A portion unrelated to the description is omitted in order to obviously describe the present disclosure, and the same or similar components are denoted by the same reference numeral throughout the specification. In addition, some components shown in the accompanying drawings are exaggerated, omitted, or schematically shown, and the size of each component does not exactly reflect its real size.

It should be understood that the accompanying drawings are provided only to allow the embodiments of the present disclosure to be easily understood, and the spirit of the present disclosure is not limited to the accompanying drawings and includes all the modifications, equivalents, and substitutions included in the spirit and scope of the present disclosure.

Terms including ordinal numbers such as “first” and “second” may be used to describe various components. However, these components are not limited to these terms. These terms are used only to distinguish one component and another component from each other.

In addition, when an element such as a layer, a film, a region, or a plate is referred to as being “on” or “above” another element, the element may be “directly on” another element or may have a third element interposed therebetween. On the other hand, when an element is referred to as being “directly on” another element, there is no third element interposed therebetween. In addition, when an element is referred to as being “on” or “above” a reference element, the element may be disposed on or below the reference element, and may not necessarily be “on” or “above” the reference element in an opposite direction of gravity.

It should be further understood that the terms such as “include” and “have”, used in the specification, specify the presence of features, numerals, steps, operations, components, parts, or combinations thereof, mentioned in the specification, and do not preclude the presence or addition of one or more other features, numerals, steps, operations, components, parts, or combinations thereof. Accordingly, when any one part “includes” any one component, it may indicate the inclusion of other components rather than the exclusion of other components unless explicitly described to the contrary.

In addition, throughout the specification, an expression “on the plane” may indicate a case where a target is viewed from the top, and an expression “on the cross section” may indicate a case where a cross section of the target taken in a vertical direction is viewed from its side.

In addition, when it is mentioned that any component is “connected to” another component, it may not only indicate that two or more components are directly connected with each other, but also indicate that two or more components are connected with each other indirectly through a third component, may not only indicate that two or more components are physically connected with each other, but also indicate that two or more components are electrically connected with each other, or two or more components are a single entity although referred to by different names based on their locations or functions.

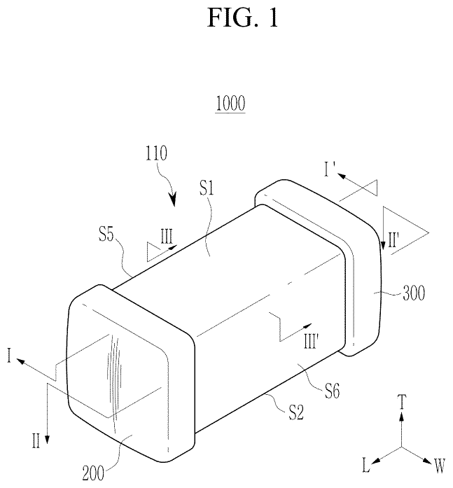

FIG. 1 is a perspective view schematically showing a multilayer ceramic capacitor according to an embodiment.

Referring to FIG. 1, a multilayer ceramic capacitor 1000 according to the present embodiment may include a body 110, a first external electrode 200, and a second external electrode 300.

First, defining directions to clearly describe the present embodiment, a T-axis, an L-axis, and a W-axis shown in the drawings indicate axes representing the first, second, and third directions of the multilayer ceramic capacitor 1000, respectively.

The first direction (T-axis direction) may be a direction perpendicular to a wide surface (main surface) of sheet-shaped components. For example, the first direction (T-axis direction) may be used as the same concept as a direction in which dielectric layers 140 are stacked. Hereinafter, if necessary, the first direction will be referred to as a “thickness direction”.

The second direction (L-axis direction) may be a direction parallel to the wide surface (main surface) of the sheet-shaped components and intersecting (or perpendicular to) the thickness direction (T-axis direction). For example, the second direction (L-axis direction) may be a direction in which the first external electrode 200 and the second external electrode 300 oppose each other. Hereinafter, if necessary, the second direction will be referred to as a “length direction”.

The third direction (W-axis direction) may be a direction parallel to the wide surface (main surface) of the sheet-shaped components and simultaneously intersecting (or perpendicular to) the first direction (T-axis direction) and the second direction (L-axis direction). Hereinafter, if necessary, the third direction will be referred to as a “width direction”.

The body 110 may have a substantially hexahedral shape, but the present embodiment is not limited thereto. Due to shrinkage during sintering, the body 110 may have a substantially hexahedral shape, although not a fully hexahedral shape. For example, the body 110 may have a substantially rectangular hexahedral shape, but corner or vertex portions may have a round shape.

In the present embodiment, for convenience of description, surfaces of the body 110 that oppose each other in the thickness direction (T-axis direction) are defined as a first surface S1 and a second surface S2, surfaces of the body 110 that oppose each other in the length direction (L-axis direction) and connect the first surface S1 with the second surface S2 are defined as a third surface S3 and a fourth surface S4, and surfaces of the body 110 that oppose each other in the width direction (W-axis direction) and connect the first surface S1 with the second surface S2 are defined as a fifth surface S5 and a sixth surface S6.

Therefore, the first direction in which the first surface S1 and the second surface S2 oppose each other, may be the thickness direction (T-axis direction), and the second and third directions that are perpendicular to the first direction and perpendicular to each other may be the length direction (L-axis direction) and the width direction (W-axis direction) or the width direction (W-axis direction) and the length direction (L-axis direction), respectively.

A length of the body 110 may refer to, based on an optical microscope or scanning electron microscope (SEM) photograph of a cross-section taken along the length direction (L-axis direction)-the thickness direction (T-axis direction) at a center of the body 110 in the width direction (W-axis direction), a maximum value of lengths of a plurality of line segments that connect two outermost boundary lines facing each other in the length direction (L-axis direction) of the body 110 shown in the above cross-sectional photograph and are parallel to the length direction (L-axis direction). Other methods and/or tools appreciated by one of ordinary skill in the art, even if not described in the present disclosure, may also be used. Meanwhile, the length of the body 110 may refer to a minimum value of lengths of a plurality of line segments that connect two outermost boundary lines facing each other in the length direction (L-axis direction) of the body 110 shown in the above cross-sectional photograph and are parallel to the length direction (L-axis direction). On the other hand, the length of the body 110 may refer to an arithmetic mean value of lengths of at least two of a plurality of line segments that connect two outermost boundary lines facing each other in the length direction (L-axis direction) of the body 110 shown in the above cross-sectional photograph and are parallel to the length direction (L-axis direction). The length of the body 110 may be measured by a standard method that will be apparent to and understood by one of ordinary skill in the art.

A thickness of the body 110 may refer to, based on an optical microscope or scanning electron microscope (microscope SEM) photograph of a cross-section taken along the length direction (L-axis direction)-the thickness direction (T-axis direction) at a center of the body 110 in the width direction (W-axis direction), a maximum value of lengths of a plurality of line segments that connect two outermost boundary lines facing each other in the thickness direction (T-axis direction) of the body 110 shown in the above cross-sectional photograph and are parallel to the thickness direction (T-axis direction). Meanwhile, the thickness of the body 110 may refer to a minimum value of lengths of a plurality of line segments that connect two outermost boundary lines facing each other in the thickness direction (T-axis direction) of the body 110 shown in the above cross-sectional photograph and are parallel to the thickness direction (T-axis direction). On the other hand, the thickness of the body 110 may refer to an arithmetic mean value of lengths of at least two of a plurality of line segments that connect two outermost boundary lines facing each other in the thickness direction (T-axis direction) of the body 110 shown in the above cross-sectional photograph and are parallel to the thickness direction (T-axis direction). The thickness of the body 110 may be measured by a standard method that will be apparent to and understood by one of ordinary skill in the art.

A width of the body 110 may refer to, based on an optical microscope or scanning electron microscope (microscope SEM) photograph of a cross-section taken along the length direction (L-axis direction)-the width direction (W-axis direction) at a center of the body 110 in the thickness direction (T-axis direction), a maximum value of lengths of a plurality of line segments that connect two outermost boundary lines facing each other in the width direction (W-axis direction) of the body 110 shown in the above cross-sectional photograph and are parallel to the width direction (W-axis direction). Meanwhile, the width of the body 110 may refer to a minimum value of lengths of a plurality of line segments that connect two outermost boundary lines facing each other in the width direction (W-axis direction) of the body 110 shown in the above cross-sectional photograph and are parallel to the width direction (W-axis direction). On the other hand, the width of the body 110 may refer to an arithmetic mean value of lengths of at least two of a plurality of line segments that connect two outermost boundary lines facing each other in the width direction (W-axis direction) of the body 110 shown in the above cross-sectional photograph and are parallel to the width direction (W-axis direction). The width of the body 110 may be measured by a standard method that will be apparent to and understood by one of ordinary skill in the art.

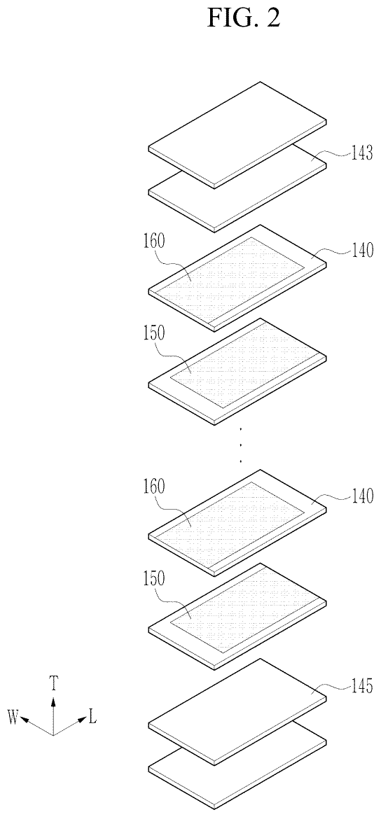

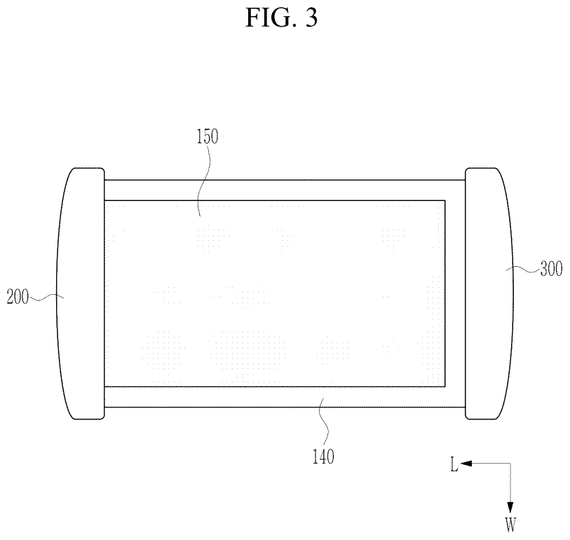

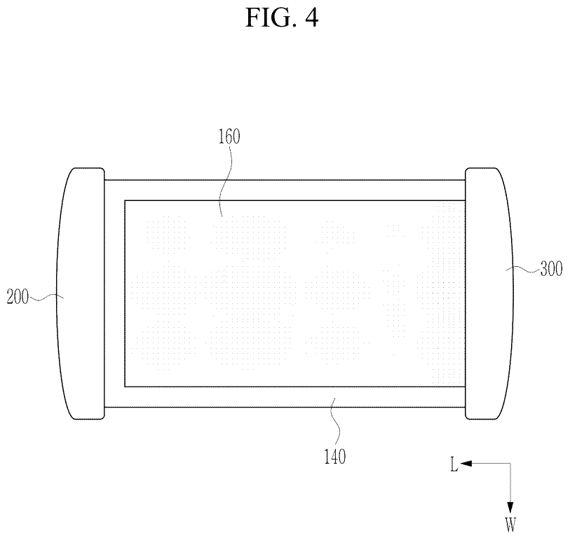

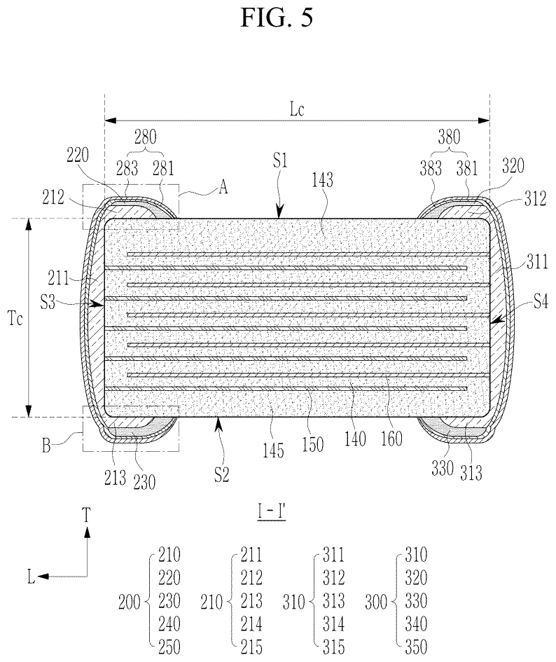

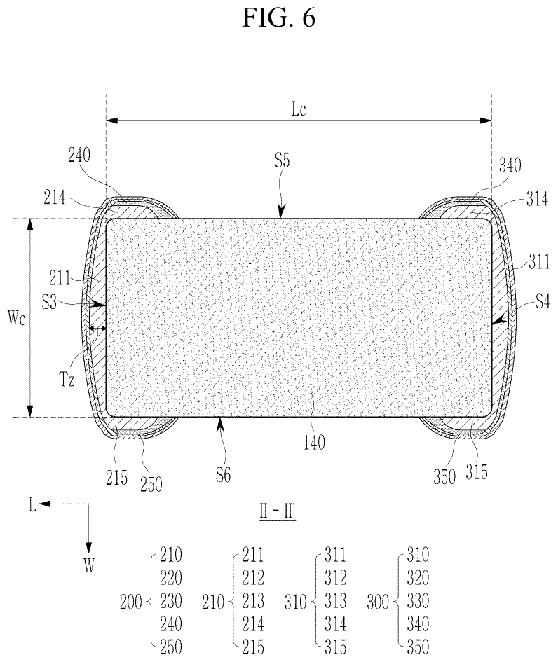

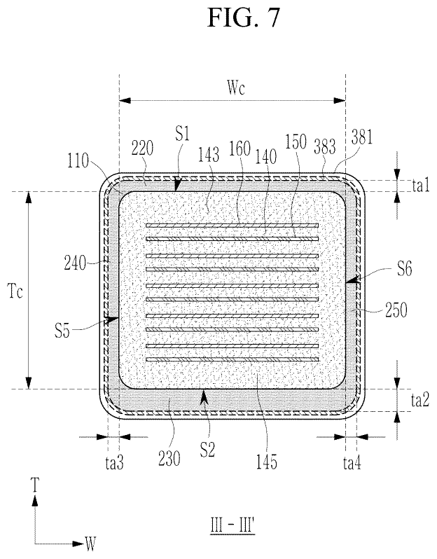

FIG. 2 is an exploded perspective view schematically showing a stacking structure of an internal electrode included in the multilayer ceramic capacitor in FIG. 1; FIG. 3 is a plan view schematically showing a first internal electrode of the multilayer ceramic capacitor in FIG. 1; and FIG. 4 is a plan view schematically showing a second internal electrode of the multilayer ceramic capacitor in FIG. 1. FIG. 5 is a cross-sectional view taken along line I-I′ in FIG. 1; FIG. 6 is a cross-sectional view taken along line II-II′ in FIG. 1; and FIG. 7 is a cross-sectional view taken along line III-III′ in FIG. 1.

Referring to FIGS. 2, 3, 4, 5, 6, and 7, the body 110 may include a plurality of dielectric layers 140, a first internal electrode 150, and a second internal electrode 160.

The plurality of dielectric layers 140 may be stacked in the thickness direction (T-axis direction) of the body 110. Boundaries between the dielectric layers 140 may be unclear. For example, the boundary between the dielectric layers 140 is difficult to confirm without using a scanning electron microscope (SEM), and the plurality of dielectric layers 140 may appear to be an integral structure.

The dielectric layer 140 may include a ceramic material. For example, the ceramic material may include a dielectric ceramic including a component such as barium titanate (BaTiO₃), calcium titanate (CaTiO₃), strontium titanate (SrTiO₃), or calcium zirconate (CaZrO₃). Further, the ceramic material may further include an auxiliary component such as a manganese (Mn) compound, an iron (Fe) compound, a chromium (Cr) compound, a cobalt (Co) compound, or a nickel (Ni) compound in addition to the above-mentioned component. For example, the dielectric layer may include (Ba₁₋ₓCaₓ)TiO₃(0□x□1), Ba(Ti_{1-y}Ca_{y})O₃(0□y□1), (Ba₁₋ₓCaₓ)(Ti_{1-y}Zr_{y})O₃(0□x□1, 0□y□1), or Ba(Ti_{1-y}Zr_{y})O₃(0□y□1), in which calcium (Ca), zirconium (Zr), or the like is partially dissolved into BaTiO₃, and the present disclosure is not limited thereto.

The dielectric layer 140 may further include at least one of a ceramic additive, an organic solvent, a plasticizer, a binder, and a dispersant. The ceramic additive may be, for example, a transition metal oxide or carbide, a rare earth element, magnesium (Mg), aluminum (Al), or the like.

The first internal electrode 150 and the second internal electrode 160 may be alternately stacked with the dielectric layer 140 interposed therebetween. This stacked structure may be repeated within the body 110, and the internal electrode closest to the first surface S1 of the body 110 may be the first internal electrode 150 or the second internal electrode 160, and the internal electrode closest to the second surface S2 may be the first internal electrode 150 or the second internal electrode 160.

The first internal electrode 150 and the second internal electrode 160 have different polarities, and may be electrically insulated from each other by the dielectric layer 140 disposed therebetween.

The first internal electrode 150 and the second internal electrode 160 may be disposed to be offset from each other in the length direction (L-axis direction) with the dielectric layer 140 interposed therebetween. An end of the first internal electrode 150 may be exposed from the third surface S3 of the body 110, and an end of the second internal electrode 160 may be exposed from the fourth surface S4 of the body 110. The end of the first internal electrode 150 that is exposed from the third surface S3 of the body 110 may be connected to the first external electrode 200. The end of the second internal electrode 160 that is exposed from the fourth surface S4 of the body 110 may be connected to the second external electrode 300.

The first internal electrode 150 and the second internal electrode 160 may each be formed by printing a conductive paste that includes a metal on a surface of the dielectric layer 140. For example, the internal electrode may be formed by printing a conductive paste that contains nickel (Ni) or a nickel (Ni) alloy on the surface of the dielectric layer using screen printing or gravure printing. However, the present embodiment is not limited thereto.

When a voltage is applied to the first external electrode 200 and the second external electrode 300, charges may accumulate between the first internal electrode 150 and the second internal electrode 160. That is, capacitance of the multilayer ceramic capacitor 1000 may be obtained between the first internal electrode 150 electrically connected to the first external electrode 200 and the second internal electrode 160 electrically connected to the second external electrode 300. The capacitance of the multilayer ceramic capacitor 1000 may be proportional to an overlapping area of the first internal electrode 150 and the second internal electrode 160, which overlap each other in the thickness direction (T-axis direction).

Referring to FIGS. 5 and 7, a first cover layer 143 and a second cover layer 145 may each be disposed on the outermost side of the body 110 in the thickness direction (T-axis direction).

The first cover layer 143 may be disposed between the first surface S1 of the body 110 and the internal electrode closest thereto. The second cover layer 145 may be disposed between the second surface S2 of the body 110 and the internal electrode closest thereto.

That is, the first cover layer 143 may be disposed on an upper portion of the uppermost internal electrode in the body 110, and the second cover layer 145 may be disposed on a lower portion of the lowermost internal electrode. The first cover layer 143 and the second cover layer 145 may have the same composition as the dielectric layer 140. The first cover layer 143 and the second cover layer 145 may be formed by stacking one or more dielectric layers on the outer surface of the uppermost internal electrode and the outer surface of the lowermost internal electrode, respectively. The first cover layer 143 and the second cover layer 145 may have a different composition from the dielectric layer 140.

The first cover layer 143 and the second cover layer 145 may serve to prevent damage to the first internal electrode 150 and the second internal electrode 160 due to physical or chemical stress.

The first external electrode 200 and the second external electrode 300 may be disposed outside the body 110.

The first external electrode 200 may be disposed on the third surface S3 of the body 110 and may extend onto the first surface S1, the second surface S2, the fifth surface S5, and the sixth surface S6. The second external electrode 300 may be disposed on the fourth surface S4 of the body 110 and may extend onto the first surface S1, the second surface S2, the fifth surface S5, and the sixth surface S6.

The first external electrode 200 may include a first electrode layer 210, a first conductive resin layer 220, a second conductive resin layer 230, a third conductive resin layer 240, and a fourth conductive resin layer 250.

The first electrode layer 210 may include a metal. For example, the first electrode layer 210 may include at least one of silver (Ag), lead (Pb), platinum (Pt), nickel (Ni), copper (Cu), or an alloy thereof.

The first electrode layer 210 may include a first connection portion 211, a first band portion 212, a second band portion 213, a third band portion 214, and a fourth band portion 215.

The first connection portion 211 covers the third surface S3 of the body 110 and is connected with and electrically connected to the exposed ends of the plurality of first internal electrodes 150.

The first band portion 212 extends from the first connection portion 211 and covers a portion of the first surface S1 of the body 110, and the second band portion 213 extends from the first connection portion 211 and covers a portion of the second surface S2 of the body 110.

The third band portion 214 extends from the first connection portion 211 and covers a portion of the fifth surface S5 of the body 110, and the fourth band portion 215 extends from the first connection portion 211 and covers a portion of the sixth surface S6 of the body 110.

The first conductive resin layer 220 covers the first band portion 212 and exposes the first connection portion 211. That is, the first conductive resin layer 220 is not disposed on the first connection portion 211.

For example, the first conductive resin layer 220 may cover a portion or all of the first band portion 212. In addition, the first conductive resin layer 220 may cover a portion of the first surface S1 of the body 110.

An outer surface of the first conductive resin layer 220 may include a curved surface.

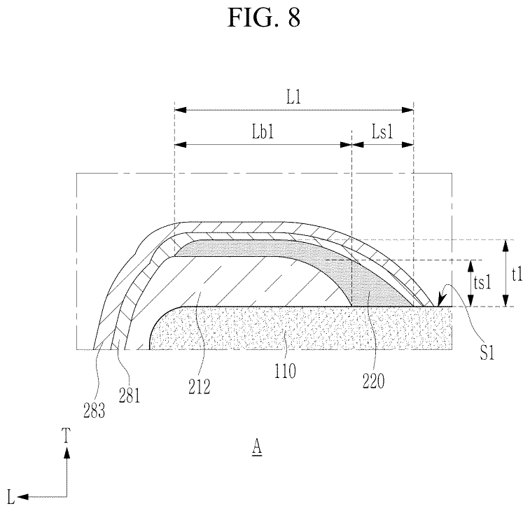

Referring to FIG. 8, a length L1 of the first conductive resin layer 220 may be greater than a length Lb1 of the first band portion 212. The length L1 of the first conductive resin layer 220 may be greater than its thickness t1.

Here, the length and thickness of the first conductive resin layer 220 and the length of the first band portion 212 may be measured based on an optical microscope or scanning electron microscope (SEM) photograph of a cross-section taken along the length direction (L-axis direction)-the thickness direction (T-axis direction) at a center of the multilayer ceramic capacitor 1000 in the width direction (W-axis direction). Other methods and/or tools appreciated by one of ordinary skill in the art, even if not described in the present disclosure, may also be used. The length of the first conductive resin layer 220 may refer to the maximum value among lengths of a plurality of line segments parallel to the length direction (L-axis direction) and connecting two outermost boundary lines of the first conductive resin layer 220 that oppose each other in the length direction (L-axis direction) shown in the above cross-sectional photograph. The thickness of the first conductive resin layer 220 may refer to the maximum value among lengths of a plurality of line segments parallel to the thickness direction (T-axis direction) and connecting two outermost boundary lines of the first conductive resin layer 220 that oppose each other in the thickness direction (T-axis direction) shown in the above cross-sectional photograph. In addition, the length of the first band portion 212 may refer to the maximum value among lengths of a plurality of line segments parallel to the length direction (L-axis direction) and connecting two outermost boundary lines of the first band portion 212 that oppose each other in the length direction (L-axis direction) shown in the above cross-sectional photograph.

A relationship between a length Lc of the body 110 and the thickness t1 of the first conductive resin layer 220 may be Lc/500≤t1≤Lc/50.

If Lc/500>t1, the thickness of the first conductive resin layer may be too thin to ensure the moisture resistance reliability of the multilayer ceramic capacitor. If t1>Lc/50, the first conductive resin layer may be excessively thick compared to the thickness of the multilayer ceramic capacitor, it may be difficult to ensure the capacitance of the multilayer ceramic capacitor relative to its size.

The thickness t1 of the first conductive resin layer 220 may be 1μm or more.

Meanwhile, in a region where the first conductive resin layer 220 covers the first surface S1 of the body 110, a length Ls1 of the first conductive resin layer 220 may be greater than its thickness ts1. That is, in the corresponding region, the length Ls1 of a portion where the first conductive resin layer 220 and the first surface S1 are in contact with each other may be greater than the thickness ts1 of the first conductive resin layer 220 in the corresponding region.

The second conductive resin layer 230 covers the second band portion 213 and exposes the first connection portion 211. That is, the second conductive resin layer 230 is not disposed on the first connection portion 211.

For example, the second conductive resin layer 230 may cover a portion or all of the second band portion 213. In addition, the second conductive resin layer 230 may cover a portion of the second surface S2 of the body 110.

An outer surface of the second conductive resin layer 230 may include a curved surface.

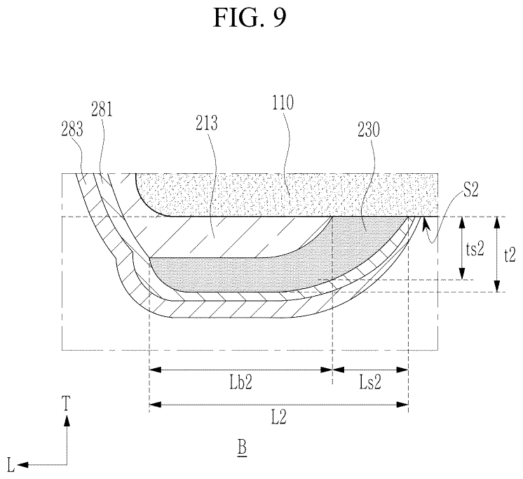

Referring to FIG. 9, a length L2 of the second conductive resin layer 230 may be greater than a length Lb2 of the second band portion 213. The length L2 of the second conductive resin layer 230 may be greater than its thickness t2.

Here, the length and thickness of the second conductive resin layer 230 and a length of the second band portion 213 may be measured based on an optical microscope or scanning electron microscope (SEM) photograph taken along the length direction (L-axis direction)-the thickness direction (T-axis direction) at a center of the multilayer ceramic capacitor 1000 in the width direction (W-axis direction). Other methods and/or tools appreciated by one of ordinary skill in the art, even if not described in the present disclosure, may also be used. The specific measurement method is the same as the measurement method for the length and thickness of the first conductive resin layer 220 and the length of the first band portion 212 described above, so a redundant description thereof will be omitted.

A relationship between the length Lc of the body 110 and the thickness t2 of the second conductive resin layer 230 may be Lc/500≤t2≤Lc/50.

If Lc/500>t2, the thickness of the second conductive resin layer may be too thin to ensure the moisture resistance reliability of the multilayer ceramic capacitor. If t2>Lc/50, the second conductive resin layer may be excessively thick compared to the multilayer ceramic capacitor, it may be difficult to ensure the capacitance of the multilayer ceramic capacitor relative to its size.

Meanwhile, in a region where the second conductive resin layer 230 covers the second surface S2 of the body 110, a length Ls2 of the second conductive resin layer 230 may be greater than its thickness ts2. That is, in the corresponding region, the length Ls2 of a portion where the second conductive resin layer 230 and the second surface S2 are in contact with each other may be greater than the thickness ts2 of the second conductive resin layer 230 in the corresponding region.

According to the present embodiment, when the multilayer ceramic capacitor 1000 is mounted on a board, the second conductive resin layer 230 is disposed on a mounting side.

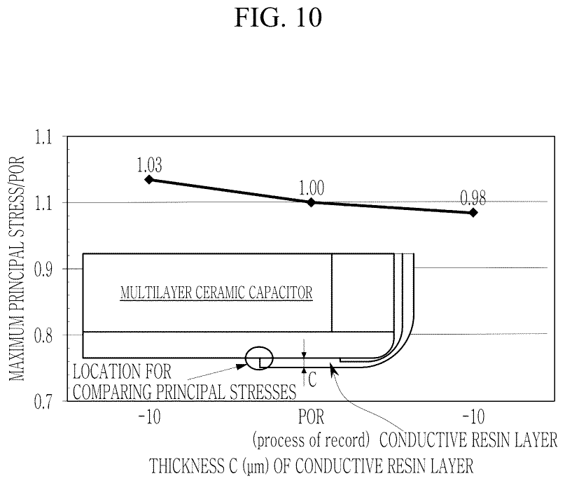

FIG. 10 is a graph showing a result of a relative comparison of stress changes as the thickness of a conductive resin layer increases.

Referring to FIG. 10, it can be seen that compared to the conventional process of record (POR), the stress decreases as the conductive resin layer of the multilayer ceramic capacitor becomes thicker. Therefore, according to the present embodiment, the bending strength characteristics of the multilayer ceramic capacitor may be improved by thickening the second conductive resin layer 230 disposed on the mounting surface.

The third conductive resin layer 240 covers the third band portion 214 and exposes the first connection portion 211. That is, the third conductive resin layer 240 is not disposed on the first connection portion 211. For example, the third conductive resin layer 240 may cover a portion or all of the third band portion 214. In addition, the third conductive resin layer 240 may cover a portion of the fifth surface S5 of the body 110.

The fourth conductive resin layer 250 covers the fourth band portion 215 and exposes the first connection portion 211. That is, the fourth conductive resin layer 250 is not disposed on the first connection portion 211. For example, the fourth conductive resin layer 250 may cover a portion or all of the fourth band portion 215. In addition, the fourth conductive resin layer 250 may cover a portion of the sixth surface S6 of the body 110.

Referring to FIG. 7, the first conductive resin layer 220 may have a first average thickness ta1, the second conductive resin layer 230 may have a second average thickness ta2, the third conductive resin layer 240 may have a third average thickness ta3, and the fourth conductive resin layer 250 may have a fourth average thickness ta4.

The second average thickness ta2 of the second conductive resin layer 230 may be greater than the first average thickness ta1 of the first conductive resin layer 220. For example, the second average thickness ta2 of the second conductive resin layer 230 may be at least twice the first average thickness ta1 of the first conductive resin layer 220.

In an embodiment, the first average thickness ta1, the third average thickness ta3, and the fourth average thickness ta4 may all be less than the second average thickness ta2.

In another embodiment, the first average thickness ta1, the third average thickness ta3, and the fourth average thickness ta4 may be the same and all less than the second average thickness ta2.

In still another embodiment, the first average thickness ta1 and the fourth average thickness ta4 may be the same and both less than the second average thickness ta2 and the third average thickness ta3. Here, the third average thickness ta3 may be less than the second average thickness ta2.

In still another embodiment, the first average thickness ta1 and the third average thickness ta3 may be the same and both less than the second average thickness ta2 and the fourth average thickness ta4. Here, the fourth average thickness ta4 may be less than the second average thickness ta2.

Here, the first average thickness ta1, the second average thickness ta2, the third average thickness ta3, and the fourth average thickness ta4 may be measured based on an optical microscope or scanning electron microscope (SEM) photograph of a cross-section taken along the width direction (W-axis direction)-the thickness direction (T-axis direction) at a center of one external electrode of the multilayer ceramic capacitor 1000 in the length direction (L-axis direction). Other methods and/or tools appreciated by one of ordinary skill in the art, even if not described in the present disclosure, may also be used. The first average thickness ta1 may be the arithmetic mean value of the thickness of the first conductive resin layer 220 shown in the above cross-sectional photograph, measured at ten equally spaced points in the width direction (W-axis direction). The above-mentioned ten points may be designated within a range corresponding to 60% of a width Wc of the body 110. For example, referring to FIG. 7, the thickness of the first conductive resin layer 220 can be measured at ten equally spaced points within a range excluding a range corresponding to 20% of the width Wc of the body 110 from the left and right sides of the body 110, and then the arithmetic mean can be taken to obtain the first average thickness ta1. The second average thickness ta2 may also be obtained in the same manner.

Meanwhile, the third average thickness ta3 may be the arithmetic mean value of the thickness of the third conductive resin layer 240 shown in the above cross-sectional photograph, measured at ten equally spaced points in the thickness direction (T-axis direction). The above-mentioned ten points may be designated within a range corresponding to 60% of a thickness Tc of the body 110. For example, referring to FIG. 7, the thickness of the second conductive resin layer 230 can be measured at ten equally spaced points within a range excluding a range corresponding to 20% of the thickness Tc of the body 110 from the upper and lower sides of the body 110, and then the arithmetic mean can be taken to obtain the third average thickness ta3. The fourth average thickness ta4 may also be obtained in the same manner.

Referring to FIG. 6, the body 110 may have the length Lc, and the first connection portion 211 may have a thickness Tz.

A relationship between the length Lc of the body 110 and the thickness Tz of the first connection portion 211 may be Lc/250≤Tz≤Lc/25.

If Lc/250>Tz, the thickness of the first connection portion may be too thin to ensure the moisture resistance reliability of the multilayer ceramic capacitor. If Tz>Lc/25, the first connection portion may be excessively thick compared to the length of the multilayer ceramic capacitor, which may reduce the bending strength.

Here, the thickness of the first connection portion 211 may be measured based on an optical microscope or scanning electron microscope (SEM) photograph of a cross-section taken along the length direction (L-axis direction)-the thickness direction (T-axis direction) at a center of the multilayer ceramic capacitor 1000 in the width direction (W-axis direction). Other methods and/or tools appreciated by one of ordinary skill in the art, even if not described in the present disclosure, may also be used. The thickness of the first connection portion 211 may refer to the maximum value among lengths of a plurality of line segments parallel to the length direction (L-axis direction) and connecting two outermost boundary lines of the first connection portion 211 that oppose each other in the length direction (L-axis direction), which are shown in the above cross-sectional photograph.

The first conductive resin layer 220 may include a metal and resin.

For example, the metal included in the first conductive resin layer 220 may include copper (Cu), silver (Ag), nickel (Ni), tin (Sn), or an alloy thereof.

For example, the resin included in the first conductive resin layer 220 may include a variety of thermosetting resins known in the art, such as epoxy resin, phenol resin, urethane resin, silicone resin, or polyimide resin.

After the first electrode layer 210 is formed, a conductive resin composition comprising a metal powder and a thermosetting resin may be applied onto the first electrode layer 210. Here, the thermosetting resin may be a bisphenol A resin, glycol epoxy resin, Novolac epoxy resin, or a resin which has a low molecular weight and is liquid at room temperature among derivatives thereof, but is not limited thereto. For example, the conductive resin composition may be prepared by mixing a silver (Ag) powder, a copper (Cu) powder, a silver (Ag)-coated copper (Cu) powder, a tin (Sn)-based solder powder, and thermosetting resin and then dispersing the mixture by using a 3-roll mill. The tin (Sn)-based solder powder may include at least one of tin (Sn), Sn_{96.5}Ag_{3.0}Cu_{0.5}, Sn₄₂Bi₅₈, and Sn₇₂Bi₂₈, but the disclosure is not limited thereto. Thereafter, the conductive resin composition disposed on the first connection portion 211 may be removed, and then, the first conductive resin layer 220 is formed on the first band portion 212 through a curing heat treatment. Accordingly, the first connection portion 211 may be disposed on the third surface S3 of the body 110, and the first band portion 212 and the first conductive resin layer 220 may be disposed on the first surface S1.

Unlike the present embodiment, if both the electrode layer and the resin layer covering the electrode layer are disposed on the third surface S3 of the body 110, the resin layer has lower electrical connectivity than the electrode layer, so equivalent series resistance (ESR) of the first external electrode may increase. There is also a risk of lifting due to out-gassing from the resin layer during a high-temperature reflow process. Furthermore, since the resin layer is present on the electrode layer, the external electrode may be thick and a relative volume of the body may be small compared to a case in which only the electrode layer is present, resulting in that effective capacity of the multilayer ceramic capacitor is reduced.

On the other hand, according to the present embodiment, the first connection portion 211 is disposed on the third surface S3 of the body 110 and the first conductive resin layer 220 is not disposed on the third surface S3, and thus, the aforementioned problem may not occur.

The second conductive resin layer 230, the third conductive resin layer 240, and the fourth conductive resin layer 250 may include the same or similar components as those included in the first conductive resin layer 220 described above and may be formed in the same manner as the first conductive resin layer 220, so a redundant description thereof will be omitted.

The multilayer ceramic capacitor 1000 may further include a first plating layer 280.

The first plating layer 280 may cover the first external electrode 200. The first plating layer 280 may include a first layer 281 and a second layer 283. The first layer 281 may be disposed on the first external electrode 200, and the second layer 283 may be disposed on the first layer 281. The first layer 281 may include nickel (Ni) and the second layer 283 may include tin (Sn), but the present embodiment is not limited thereto.

The second external electrode 300 may include a second electrode layer 310, a fifth conductive resin layer 320, a sixth conductive resin layer 330, a seventh conductive resin layer 340, and an eighth conductive resin layer 350.

The second electrode layer 310 may include a metal. For example, the second electrode layer 310 may include at least one of silver (Ag), lead (Pb), platinum (Pt), nickel (Ni), copper (Cu), or an alloy thereof.

The second electrode layer 310 may include a second connection portion 311, a fifth band portion 312, a sixth band portion 313, a seventh band portion 314, and an eighth band portion 315.

The second connection portion 311 covers the fourth surface S4 of the body 110 and is connected with and electrically connected to the exposed ends of the plurality of second internal electrodes 160.

The fifth band portion 312 extends from the second connection portion 311 and covers a portion of the first surface S1 of the body 110, and the sixth band portion 313 extends from the second connection portion 311 and covers a portion of the second surface S2 of the body 110.

The seventh band portion 314 extends from the second connection portion 311 and covers a portion of the fifth surface S5 of the body 110, and the eighth band portion 315 extends from the second connection portion 311 and covers a portion of the sixth surface S6 of the body 110.

The fifth conductive resin layer 320 covers the fifth band portion 312 and exposes the second connection portion 311. That is, the fifth conductive resin layer 320 is not disposed on the second connection portion 311.

For example, the fifth conductive resin layer 320 may cover a portion or all of the fifth band portion 312. In addition, the fifth conductive resin layer 320 may cover a portion of the first surface S1 of the body 110.

The sixth conductive resin layer 330 covers the sixth band portion 313 and exposes the second connection portion 311. That is, the sixth conductive resin layer 330 is not disposed on the second connection portion 311.

For example, the sixth conductive resin layer 330 may cover a portion or all of the sixth band portion 313. In addition, the sixth conductive resin layer 330 may cover a portion of the second surface S2 of the body 110.

An outer surface of the fifth conductive resin layer 320 may include a curved surface, and an outer surface of the sixth conductive resin layer 330 may include a curved surface.

The fifth conductive resin layer 320 may include a metal and resin.

For example, the metal included in the fifth conductive resin layer 320 may include copper (Cu), silver (Ag), nickel (Ni), tin (Sn), or an alloy thereof.

For example, the resin included in the fifth conductive resin layer 320 may include a variety of thermosetting resins known in the art, such as epoxy resin, phenol resin, urethane resin, silicone resin, or polyimide resin.

The sixth conductive resin layer 330, the seventh conductive resin layer 340, and the eighth conductive resin layer 350 may include the same or similar components as those of the fifth conductive resin layer 320 described above so a redundant description thereof will be omitted.

The multilayer ceramic capacitor 1000 may further include a second plating layer 380.

The second plating layer 380 may cover the second external electrode 300. The second plating layer 380 may include a third layer 381 and a fourth layer 383. The third layer 381 may be disposed on the second external electrode 300, and the fourth layer 383 may be disposed on the third layer 381. The third layer 381 may include nickel (Ni), the fourth layer 383 may include tin (Sn), but the present embodiment is not limited thereto.

The second external electrode 300 corresponds to the first external electrode 200 except for its location, so a redundant description thereof will be omitted.

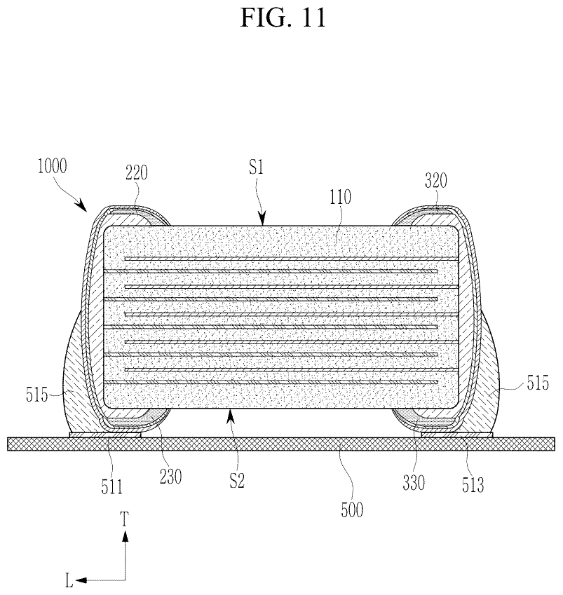

FIG. 11 is a cross-sectional view schematically showing the multilayer ceramic capacitor shown in FIG. 1 as mounted on a circuit board.

Referring to FIG. 11, the multilayer ceramic capacitor 1000 may be connected via a conductive bonding member 515 to a first electrode pad 511 and a second electrode pad 513 disposed on an upper surface of a circuit board 500.

Here, the second surface S2 of the body 110 may be the mounting surface. Accordingly, the multilayer ceramic capacitor 1000 may be electrically connected to the first and second electrode pads 512 and 513 of the circuit board 500 with the second conductive resin layer 230 and the sixth conductive resin layer 330, respectively, opposing the top surface of the circuit board 500. The conductive bonding member 515 may include, for example, solder.

Although the embodiments of the present disclosure have been described, it should be understood that the present disclosure is not limited to the disclosed embodiments. Various modifications may be made within the scopes of the claims, the description of the present disclosure and the accompanying drawings, which also fall within the scope of the present disclosure.

What is claimed is:

1. A multilayer ceramic capacitor (MLCC) comprising:
a body comprising a plurality of internal electrodes stacked in a first direction with a dielectric layer interposed therebetween, the body including a first surface and a second surface disposed opposite each other in the first direction; and
an external electrode disposed outside the body, and connected to the plurality of internal electrodes,
wherein the external electrode includes
a connection portion connected to the plurality of internal electrodes in a second direction intersecting the first direction,
a first band portion connected to the connection portion and covering a portion of the first surface,
a second band portion connected to the connection portion and covering a portion of the second surface,
a first conductive resin layer covering the first band portion and exposing the connection portion, and
a second conductive resin layer covering the second band portion and exposing the connection portion, and
wherein a thickness of the second conductive resin layer is greater than a thickness of the first conductive resin layer.

2. The MLCC of claim 1, wherein
an average thickness of the second conductive resin layer is at least twice an average thickness of the first conductive resin layer.

3. The MLCC of claim 1, wherein
the first conductive resin layer covers a portion of the first band portion, and
the second conductive resin layer covers a portion of the second band portion.

4. The MLCC of claim 1, wherein
the first conductive resin layer covers a portion of the first surface, and
the second conductive resin layer covers a portion of the second surface.

5. The MLCC of claim 4, wherein
in a region where the first conductive resin layer covers the first surface,
a length of a portion where the first conductive resin layer and the first surface are in contact with each other is greater than the thickness of the first conductive resin layer.

6. The MLCC of claim 4, wherein
in a region where the second conductive resin layer covers the second surface,
a length of a portion where the second conductive resin layer and the second surface are in contact with each other is greater than the thickness of the second conductive resin layer.

7. The MLCC of claim 1, wherein
an outer surface of the first conductive resin layer includes a curved surface, and
an outer surface of the second conductive resin layer includes a curved surface.

8. The MLCC of claim 1, wherein
a length of the first conductive resin layer is greater than a length of the first band portion, and
a length of the second conductive resin layer is greater than a length of the second band portion.

9. The MLCC of claim 1, wherein
a length of the first conductive resin layer is greater than a thickness thereof, and
a length of the second conductive resin layer is greater than a thickness thereof.

10. The MLCC of claim 1, wherein
Lc/500≤t1<t2≤Lc/50, where a length of the body is Lc, the thickness of the first conductive resin layer is t1, and the thickness of the second conductive resin layer is t2.

11. The MLCC of claim 1, wherein
Lc/250≤Tz≤Lc/25, where a length of the body is Lc, and a thickness of the connection portion is Tz.

12. The MLCC of claim 1, wherein
the body further includes a third surface and a fourth surface disposed opposite each other in a third direction simultaneously intersecting the first direction and the second direction,
the external electrode further includes
a third band portion connected to the connection portion and covering a portion of the third surface,
a fourth band portion connected to the connection portion and covering a portion of the fourth surface,
a third conductive resin layer covering the third band portion, and
a fourth conductive resin layer covering the fourth band portion, and
wherein the first conductive resin layer, the third conductive resin layer, and the fourth conductive resin layer have the same average thickness.

13. The MLCC of claim 12, wherein
the first conductive resin layer, the third conductive resin layer, and the fourth conductive resin layer have the same average thickness that is smaller than an average thickness of the second conductive resin layer.

14. The MLCC of claim 1, wherein
the body further includes a third surface and a fourth surface disposed opposite each other in a third direction simultaneously intersecting the first direction and the second direction,
the external electrode further includes
a third band portion connected to the connection portion and covering a portion of the third surface,
a fourth band portion connected to the connection portion and covering a portion of the fourth surface,
a third conductive resin layer covering the third band portion, and
a fourth conductive resin layer covering the fourth band portion, and
wherein each of an average thickness of the first conductive resin layer, an average thickness of the third conductive resin layer, and an average thickness of the fourth conductive resin layer is smaller than an average thickness of the second conductive resin layer.

15. The MLCC of claim 1, wherein
the body further includes a third surface and a fourth surface disposed opposite each other in a third direction simultaneously intersecting the first direction and the second direction,
the external electrode further includes
a third band portion connected to the connection portion and covering a portion of the third surface,
a fourth band portion connected to the connection portion and covering a portion of the fourth surface,
a third conductive resin layer covering the third band portion, and
a fourth conductive resin layer covering the fourth band portion, and
wherein the first conductive resin layer and the fourth conductive resin layer have the same average thickness that is smaller than each of an average thickness of the second conductive resin layer and an average thickness of the third conductive resin layer.

16. The MLCC of claim 15, wherein
the average thickness of the third conductive resin layer is smaller than the average thickness of the second conductive resin layer.

17. The MLCC of claim 1, wherein
the body further includes a third surface and a fourth surface disposed opposite each other in a third direction simultaneously intersecting the first direction and the second direction,
the external electrode further includes
a third band portion connected to the connection portion and covering a portion of the third surface,
a fourth band portion connected to the connection portion and covering a portion of the fourth surface,
a third conductive resin layer covering the third band portion, and
a fourth conductive resin layer covering the fourth band portion, and
wherein the first conductive resin layer and the third conductive resin layer have the same average thickness that is smaller than each of an average thickness of the second conductive resin layer and an average thickness of the fourth conductive resin layer.

18. The MLCC of claim 17, wherein
the average thickness of the fourth conductive resin layer is smaller than the average thickness of the second conductive resin layer.

19. The MLCC of claim 1, wherein
the first conductive resin layer and the second conductive resin layer each includes a metal and a resin.

20. The MLCC of claim 1, further comprising
a plating layer covering the external electrode.
